(19) United States
(12) Patent Application Publication
(10) Pub. No.: US 2010/0109538 A1
(43) Pub. Date: May 6, 2010

(54) CONTINUOUS CURRENT CONTROL CIRCUIT MODULES OF SERIES STRING BULBS TYPE

(76) Inventor: MEI-LING PENG, Taipei (TW)

Correspondence Address: LEONG C LEI, PMB # 1008, 1867 YGNACIO VALLEY ROAD, WALNUT CREEK, CA, 94598, US

(21) Appl. No.: 12/685,683

(22) Filed: Jan. 12, 2010

Related U.S. Application Data
(63) Continuation-in-part of application No. 11/062,835, filed on Feb. 23, 2005, now Pat. No. 7,242,148.

(51) Int. Cl. H05B 37/00; F21S 4/00

(52) U.S. Cl. 315/185 R

(57) ABSTRACT

The invention relates to a continuous current control circuit module of series string bulbs type, which can maintain the normal current and voltage across each of the bulbs when any of series connected bulbs burn out. The string includes a shunt in every bulb assemblies, which is especially a Zener diode with a tiny volume. The shunt will thus provide a secure electrical connection of the light string whenever any bulb is burn out or broken.

This application is a continuation-in-part of U.S. application Ser. No. 11/062,835 filed on 23 Feb. 2005, now U.S. Pat. No. 7,242,148.

### FIELD OF THE INVENTION

The present invention relates to an improvement of a continuous current control circuit module of series string bulbs, which includes a secure shunt for maintaining electrical connection of the light string effectively.

### BACKGROUND OF THE INVENTION

In prior art, continuous current control circuit modules of series string bulbs in order to maintain their electrical connection whenever any bulb assembly is broken or loosen have different structures, such as U.S. Pat. No. 6,323,597, U.S. Pat. No. 5,731,667, and U.S. Pat. No. 5,886,423. In these structures, as shown in FIGS. 1 to 3, they include large volumes and are complicated, which will not be capable easily to be assembled the electronic pieces in such tiny space of a decorative bulb (FIG. 4). Or it needs high cost to complete such assembly. Therefore, the said patents are lack somehow of utility.

### SUMMARY OF THE INVENTION

The present invention is based on U.S. Pat. No. 7,242,148 to provide an improved continuous current control circuit module of series string bulbs having secure shunt, which uses Zener diode having a small volume to replace previous TRIAC (THYristor) in each circuit module to obtain the effect of improvement. Now, accompanying with the following drawings, the character of the present invention will be described here and after.

### BRIEF DESCRIPTION OF THE DRAWINGS

FIG. 1 is a schematic view showing an electrical circuit of U.S. Pat. No. 5,886,423.

FIG. 2 is a schematic view showing an electrical circuit of U.S. Pat. No. 5,731,667.

FIG. 3 is a schematic view showing an electrical circuit of U.S. Pat. No. 6,323,597.

FIG. 4 is a cross-sectional plan view showing a bulb assembly according to the present invention.

FIG. 5 is a schematic view showing an embodiment of an electrical circuit according to the present invention.

FIG. 6 is a schematic view showing another embodiment of an electrical circuit according to the present invention.

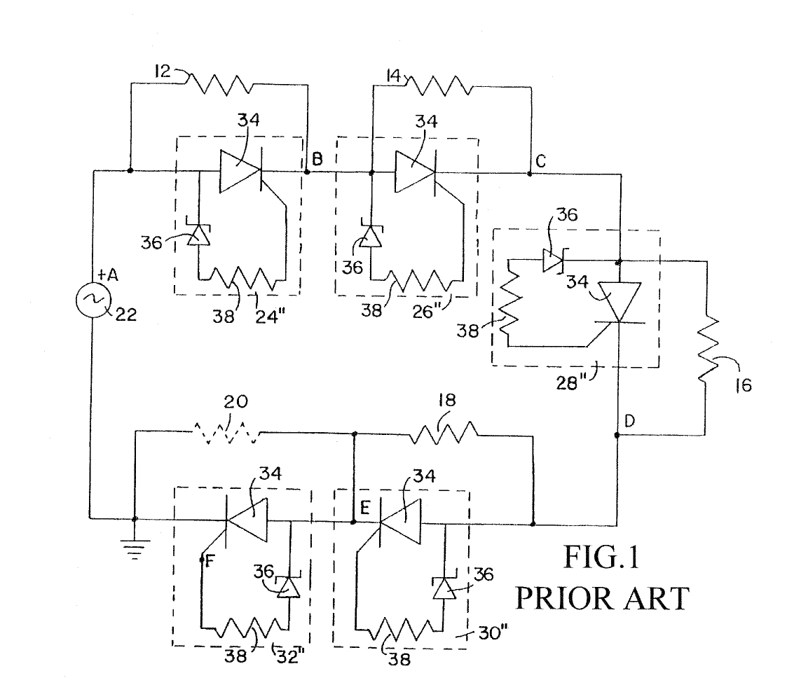

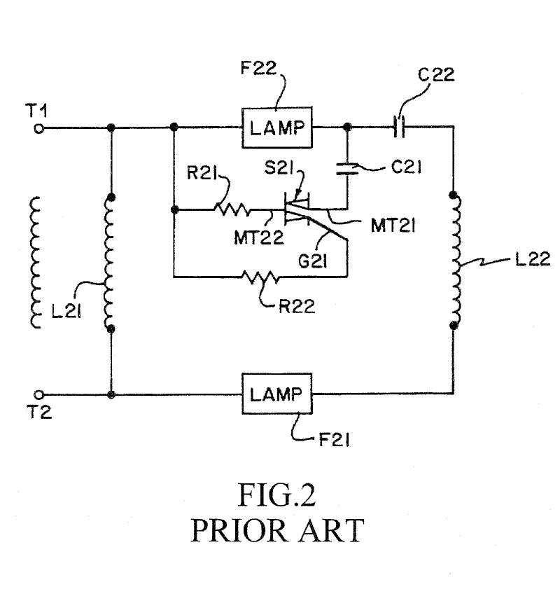

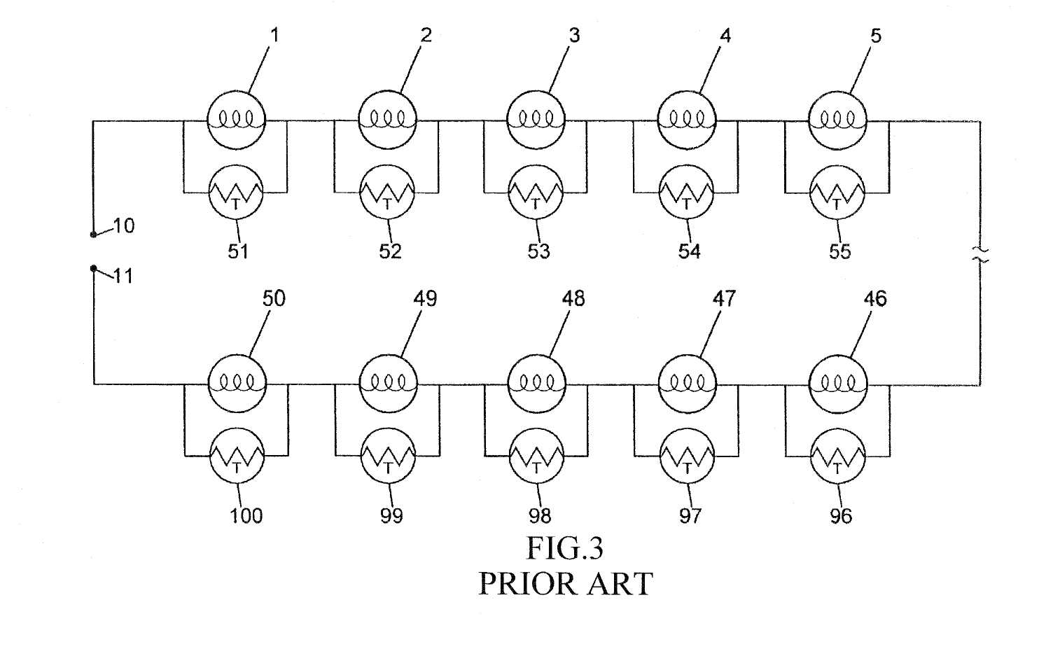

### DETAILED DESCRIPTION OF THE PREFERRED EMBODIMENT

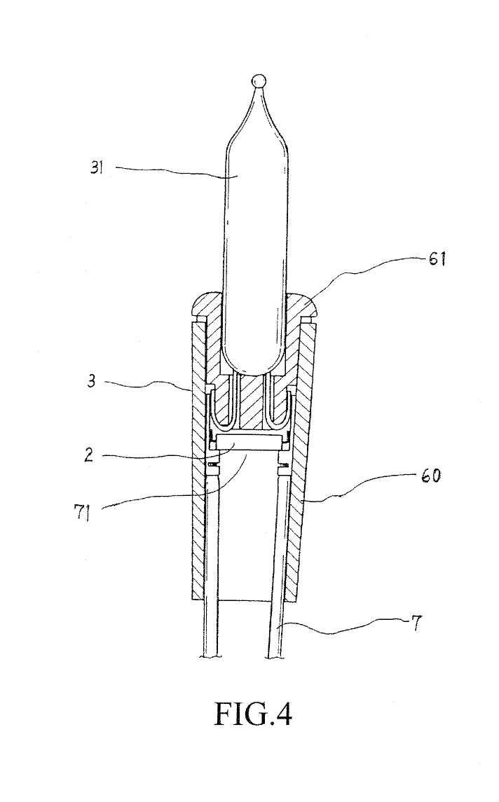

Please refer to FIG. 4; each bulb assembly (3) of the present invention includes a shell (60), a bulb holder (61), and a bulb (33). A Zener diode (2) is placed in a space (71) in the shell (60), under the holder (61), and between the electric wires (7). Since the space (71) is so small, any electronic piece received therein must be small and economic that provides utilized value therefore. A bulb (31) is connected with the bulb holder (61).

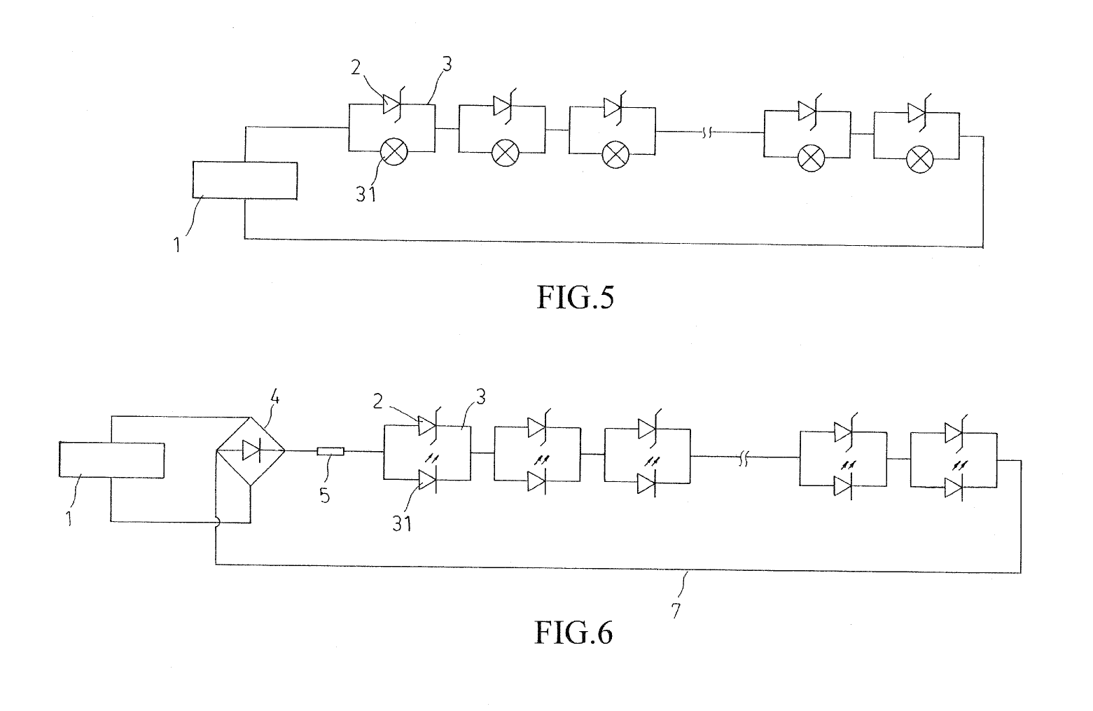

As FIG. 5, the present invention shows an improvement of a continuous current control circuit module of series string bulbs. The invention includes a power source (1) and electric wires (7), which connect with several bulb assemblies (3) in series. The improvement of the present invention is to connect a Zener diode (2) with the bulb (31) in parallel inside the shell (60).

As FIG. 6, the present invention is capable of connecting a rectifier (4) between the output end of the power source (1) and the input end of the bulb assembly (3) in case to transfer the AC current into DC current while the bulb (31) is LED bulb. A resistor (5) can be provided to stabilize the electric voltage.

In actual application, the Zener diode (2) of the present invention connected with the bulb assembly (3) provides a completed electric connection of the circuit. When the bulb (31) is normal, it is nothing at all. But when the bulb (31) is broken, the Zener diode (2) will keep the electric circuit in normal and maintains the light string in usual lighting module of decoration.

I claim:

1. A continuous current control circuit module of series string bulbs including a light string with electrical wires connecting with several bulb assemblies in series, wherein each bulb assembly including a shell, a bulb holder, and a bulb; the improvement is in that a Zener diode is connected with the bulb in parallel in each bulb assembly.

2. A continuous current control circuit module of series string bulbs as claimed in claim 1, wherein the bulb is LED when the circuit of the string connecting with a rectifier and a resistor.
